(19) United States
(12) Patent Application Publication
(10) Pub. No.: US 2005/0005585 A1
(43) Pub. Date: Jan. 13, 2005

(54) Air cleaner

(75) Inventor: Jeong-Yong Kim, Seoul (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 10/882,328

(22) Filed: Jul. 2, 2004

(30) Foreign Application Priority Data
Jul. 8, 2003 (KR) P2003-46054

(51) Int. Cl. B01D 46/00

(52) U.S. Cl. 55/467.1

(57) ABSTRACT

Air cleaner including a filter device for cleaning air introduced from an outside, a heat exchanger for heat exchanging with the air introduced from the outside, and a fan for forcing an air flow, thereby providing cleaned cool air in summer, and cleaned warm air in winter.

### This application claims the benefit of the Korean Application No. P2003-0046054 filed on Jul. 8, 2003, which is hereby incorporated by reference.

### BACKGROUND OF THE INVENTION

1. Field of the Invention

The present invention relates to air cleaners, and, more particularly, to an air cleaner, with a heat exchanger.

2. Background of Related Art

In general, the air cleaner, a kind of air conditioner, draws in and cleans polluted air, and discharges to a room, for maintaining room air more comfortable. A related art air cleaner will be described with reference to FIG. 1.

Referring to FIG. 1, the related art air cleaner is provided with a case 1 forming an outer appearance of the air cleaner, having a cover 2 for opening/closing a front, a filter device (not shown) inside of the case 1, and a fan (not shown) for forcing an air flow.

The case 1 is provided with an air inlet 2a extended in a vertical direction, particularly, at a central part of the cover 2, and an air outlet 1a on a top of the case for discharge of the air cleaned in the case. The filter device is provided with a plurality of filters having a deodoring filter, a dust collecting filter for removal of foreign matters, such as dust, and the like. The fan, in rear of the filter device, forces an air flow, is a sirocco fan which draws air in an axial direction, and discharges in a radial direction. The operation of the related art air cleaner will be described.

Polluted air is drawn into the case 1 through the air inlet 2a in the cover 2 by a suction power generated by the fan 4 in the case 1. In a course of passing through the filter device 3, the room air has various contaminants removed therefrom, and is discharged through the air outlet 1a in the top of the case 1 by the fan 4.

By repeating above process, the polluted room air is cleaned gradually, to provide a clean air to the person in the room.

However, since the related art air cleaner does not changes an air temperature, leaving a temperature of drawing air, and a temperature of discharging air the same, development of an air cleaner is required, which can provide cool air to the room in hot seasons, like summer, and provide warm air in cold seasons like winter.

### SUMMARY OF THE INVENTION

Accordingly, the present invention is directed to an air cleaner that substantially obviates one or more of the problems due to limitations and disadvantages of the related art.

An object of the present invention is to provide an air cleaner which can heat or cool discharge air according to a room temperature.

Additional features and advantages of the invention will be set forth in the description which follows, and in part will be apparent to those having ordinary skill in the art upon examination of the following or may be learned from practice of the invention. The objectives and other advantages of the invention will be realized and attained by the structure particularly pointed out in the written description and claims hereof as well as the appended drawings.

To achieve these objects and other advantages and in accordance with the purpose of the present invention, as embodied and broadly described herein, the air cleaner includes a filter device for cleaning air introduced from an outside, a heat exchanger for heat exchanging with the air introduced from the outside, and a fan for forcing an air flow.

The heat exchanger is provided to a suction side of the fan.

However, the heat exchanger is provided to a discharge side of the fan, or between the filter device and the fan.

The heat exchanger heat exchanges with the introduced air by a phase change of a phase change material.

The heat exchanger includes a heat exchange plate filled with the phase change material.

The heat exchanger plate is detachably provided to a predetermined position of an inside of the air cleaner.

The heat exchange plate is provided to an inside of the air cleaner in a low temperature state in hot weather, for cooling down the introduced air, and the heat exchange plate is provided to an inside of the air cleaner in a high temperature state in cold weather, for heating the introduced air.

The heat exchange plate includes a plurality of pass through holes for pass of the introduced air.

The fan is a sirocco fan for drawing air in an axial direction, and discharging in a circumferential direction.

In other aspect of the present invention, there is provided an air cleaner including a filter device for cleaning air introduced from an outside, a fan for forcing an air flow, a heat exchanger on a suction side of the fan having a phase change material for heat exchanging with the air introduced from the outside, and a case with an air inlet and an air outlet having the filter device, the heat exchanger, and the fan held therein.

In another aspect of the present invention, there is provided an air cleaner including a filter device for cleaning air introduced from an outside, a fan for forcing an air flow, a heat exchanger on a discharge side of the fan having a phase change material for heat exchanging with the air introduced from the outside, and a case with an air inlet and an air outlet having the filter device, the heat exchanger, and the fan held therein.

It is to be understood that both the foregoing description and the following detailed description of the present invention are exemplary and explanatory and are intended to provide further explanation of the invention claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention.

In the drawings;

FIG. 1 illustrates a perspective view of a related art air cleaner;

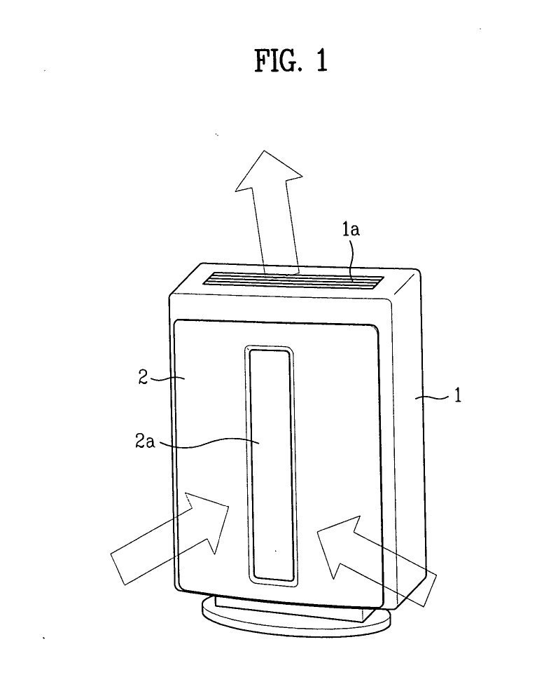

FIG. 2 illustrates a disassembled perspective view of an air cleaner in accordance with a preferred embodiment of the present invention;

FIG. 3 illustrates a section of an air cleaner in accordance with a preferred embodiment of the present invention;

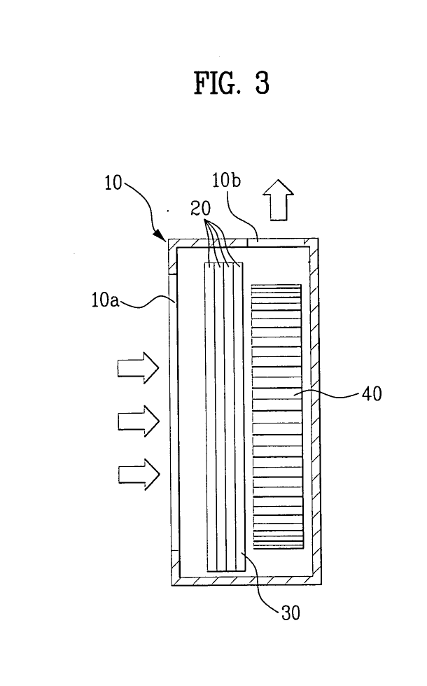

FIG. 4 illustrates a plan view of a heat exchange plate provided to an air cleaner in accordance with a preferred embodiment of the present invention; and

FIG. 5 illustrates a section of an air cleaner in accordance with other preferred embodiment of the present invention.

### DETAILED DESCRIPTION OF THE PREFERRED EMBODIMENT

Reference will now be made in detail to the preferred embodiments of the present invention, examples of which are illustrated in the accompanying drawings. In describing the embodiments, identical parts will be given the same names and reference symbols, and repetitive description of which will be omitted.

The air cleaner, a kind of air conditioner, will be described for better understanding of the present invention. The air conditioner controls a temperature, a humidity, motion, and cleanliness of air in a particular area proper to a use of purpose. For an example, the air conditioner cools, heats, or cleans room, such as residential space, office, restaurant.

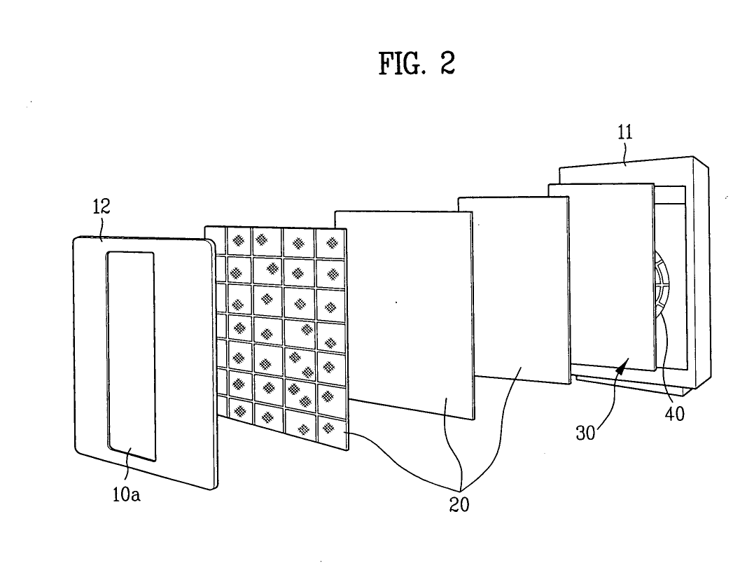

The air cleaner in accordance with a preferred embodiment of the present invention will be described with reference to FIGS. 2˜4.

Referring to FIGS. 2˜4, the air cleaner includes a case 10 forming an outer appearance, a filter device 20 in the case, a heat exchanger on one side of the filter device, and a fan 40 for forcing flow of air.

The case has a rear case 11 having an opened front, and a cover 12 for opening/closing a front of the rear case 11. The cover has an air inlet 10a for drawing air into an inside of the case 10, and the case 10 has an air outlet 10b for discharging air cleaned and heat exchanged in the case.

It is preferable that the filter device 20 includes a plurality of filters, such as a deodoring filter, a dust collecting filer, and the like, for removing smell and foreign matters, such as dust and the like from air introduced through the air inlet 10.

The heat exchanger, in rear of the filter device 20, cools/heats air passed through the filter device 20 by means of heat exchange with the air, to supply cool air in seasons like summer, and warm air to the room in seasons like cold winder.

For above function, the heat exchanger includes a heat exchange plate 30 having Phase Change Material (hereafter called as PCM) filled therein for heating or cooling the air passed through, and cleaned at the filter device 20.

The PCM is a material that changes a phase at a certain temperature, which may be a latent heat material for using latent heat generated when a material undergoes phase change from solid to liquid, or liquid to solid. That is, the PCM is a material for using latent heat absorbed, or discharged under an isothermal state at a time of phase change of the material, of which transition temperature is a temperature range the user desires.

It is preferable that the PCM is a material having large thermal capacity and latent heat, a small supercooling effect, stable in view of chemistry, and good reproducibility, and which can be used repeatedly, such as inorganic salt, paraffin wax, fat acid, and the like. Of course, even though water has great difference in freezing points from the inorganic salt, paraffin wax, and the like, water which undergoes phase changes, and has a great latent heat may be used as the PCM.

Accordingly, the PCM filled in the heat exchange plate in above embodiment absorbs heat from air introduced thereto and liquefies itself if a temperature of the air is higher than a transition temperature of the PCM, and the air is cooled, to supply cool air to the room.

Opposite to this, if air having a temperature lower than the transition temperature of the PCM is introduced, the PCM condenses to discharge heat, and the air absorbs heat from the heat discharged from the PCM, to supply warm air to the room.

The heat exchange plate 30 having the PCM filled therein may be formed of a material, such as metal like aluminum, or plastics, and the like, as far as the material meets conditions that the material has a good heat transfer coefficient to the air, and the PCM does not leak.

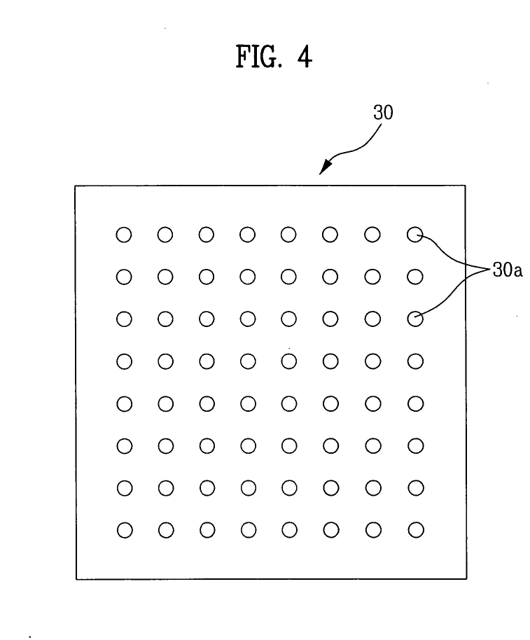

Referring to FIG. 4, the heat exchange plate 30 has a plurality of pass through holes 30a for pass the air. It is preferable that the heat exchange plate 30 has a predetermined thickness for adequate heat exchange between the air passing through the pass through holes 30a and the PCM. That is, the pass through holes 30a are provided for smooth air flow, and may be circular, oval, polygonal, or a combination to those.

The heat exchange plate 30 is detachably mounted between a suction side of the fan 40, in more detail, the filter device 20 and the fan 40. Of course, the heat exchange plate 30 may be mounted on a discharge side of the fan 30. The heat exchange plate 30 mounted on the discharge side of the fan 30 will be described in other embodiment described later.

The heat exchange plate 30 filled with PCM may be mounted in the case after discharging/storing heat in a freezing chamber/microwave oven if there is a large temperature difference between the air temperature and the PCM transition temperature.

That is, it is preferable that, if a room air temperature is higher than a proper room temperature excessively like a summer, the heat exchange plate 30 is cooled down in a freezing chamber before mounting in the case, and if a room air temperature is lower than a proper room temperature excessively like a winter, the heat exchange plate 30 is heated in a microwave oven before mounting in the case, for increasing heat exchange quantity between the heat exchange plate 30 and the air.

In the meantime, the fan 40 is a sirocco fan 10b which draws air in an axial direction, and discharges in a radial direction such that cleaned air is discharged through the air outlet in the top of the case.

The operation of the air cleaner of the present invention will be described, with reference to the attached drawings.

Upon putting the air cleaner into operation, polluted room air is drawn into the case 10 through the air inlet 10a by a suction force generated by the sirocco fan 40 in the case 10, passes through, and has contaminants and smells removed therefrom at the filter device 20, and passes through and heat exchanges at the heat exchange plate 30 filled with the PCM.

In this instance, if the air introduced into the heat exchange plate 30 is higher than the transition temperature of the PCM selected according to a proper room air temperature, the PCM in the heat exchange plate 30 is liquefied to absorb heat from the air, to cool down the air temperature, and, the cooled down air is discharged through the air outlet 10b.

If the temperature of air introduced into the heat exchange plate 30 is lower than the transition temperature of the PCM selected according to a proper room air temperature, the PCM in the heat exchange plate 30 is condensed to discharge heat to the air, to heat the air, and, the heated air is discharged through the air outlet 10b.

As the foregoing cleaning process is repeated, polluted room air becomes clean gradually, to provide cleaned air to the person in the room.

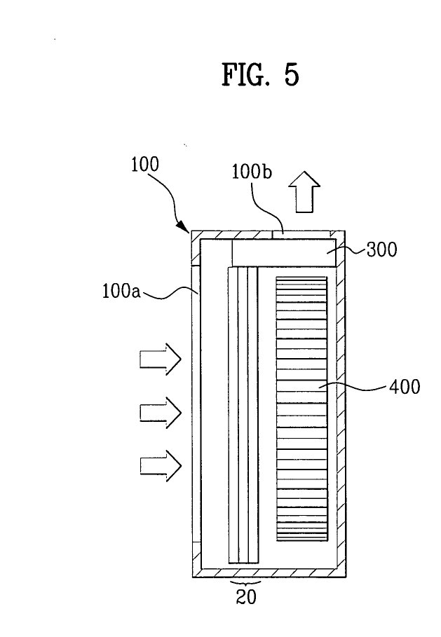

Other embodiment of the air cleaner of the present invention will be described with reference to FIG. 5.

Referring to FIG. 5, the air cleaner includes a filter device 200, a sirocco fan 400 in rear of the filter device, a heat exchange plate 300 over the sirocco fan 400, and a case 100 forming an outer appearance and holding the filter device 200, the sirocco fan 400, the heat exchange plate 300.

That is, in the embodiment, alike the foregoing embodiment, the case has an air inlet 100a in a front, and an air outlet in a top, and the heat exchange plate 300 mounted on a discharge side of the fan 400. Since the fan 400 is a sirocco fan that discharges air in a circumferential direction, the heat exchange plate 300 mounted over the fan 400 in the circumferential direction heat exchanges with the air from the fan 400, and the air heat exchanged with the heat exchange plate is discharged to the room through the air outlet.

Systems other than above is the same with the foregoing embodiment, no more description will be given.

As has been described, the air cleaner of the present invention has the following advantages.

First, the air cleaner of the present invention can supply cooled clean air to the room when the room temperature is high like summer, and heated clean air to the room when the room temperature is low like winter, as the air discharged to the room heat exchanges with the heat exchange device, such that the air is heated or cooled depending on a season.

Second, the use of phase change material in the air cleaner as a heat exchange medium permits to prevent environmental pollution, and save energy.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

1. An air cleaner comprising:
a filter device for cleaning air introduced from an outside;
a heat exchanger for heat exchanging with the air introduced from the outside; and
a fan for forcing an air flow.

2. The air cleaner as claimed in claim 1, wherein the heat exchanger is provided to a suction side of the fan.

3. The air cleaner as claimed in claim 1, wherein the heat exchanger is provided to a discharge side of the fan.

4. The air cleaner as claimed in claim 1, wherein the heat exchanger is provided between the filter device and the fan.

5. The air cleaner as claimed in claim 1, wherein the heat exchanger heat exchanges with the introduced air by a phase change of a phase change material.

6. The air cleaner as claimed in claim 5, wherein the heat exchanger includes a heat exchange plate filled with the phase change material.

7. The air cleaner as claimed in claim 6, wherein the heat exchanger plate is detachably provided to a predetermined position of an inside of the air cleaner.

8. The air cleaner as claimed in claim 7, wherein the heat exchange plate is provided to an inside of the air cleaner in a low temperature state in hot weather, for cooling down the introduced air, and the heat exchange plate is provided to an inside of the air cleaner in a high temperature state in cold weather, for heating the introduced air.

9. The air cleaner as claimed in claim 6, wherein the heat exchange plate includes a plurality of pass through holes for pass of the introduced air.

10. The air cleaner as claimed in claim 1, wherein the fan is a sirocco fan for drawing air in an axial direction, and discharging in a circumferential direction.

11. An air cleaner comprising:
a filter device for cleaning air introduced from an outside;
a fan for forcing an air flow;
a heat exchanger on a suction side of the fan having a phase change material for heat exchanging with the air introduced from the outside; and
a case with an air inlet and an air outlet having the filter device, the heat exchanger, and the fan held therein.

12. The air cleaner as claimed in claim 11, wherein the heat exchange device further includes a heat exchange plate filled with a phase change material.

13. The air cleaner as claimed in claim 12, wherein the heat exchange plate includes a plurality of pass through holes for pass of the introduced air.

14. The air cleaner as claimed in claim 13, wherein the heat exchanger plate is detachably provided to a predetermined position of an inside of the air cleaner.

15. The air cleaner as claimed in claim 11, wherein the heat exchanger is provided between the filter device and the fan.

16. An air cleaner comprising:
a filter device for cleaning air introduced from an outside;
a fan for forcing an air flow;
a heat exchanger on a discharge side of the fan having a phase change material for heat exchanging with the air introduced from the outside; and
a case with an air inlet and an air outlet having the filter device, the heat exchanger, and the fan held therein.

17. The air cleaner as claimed in claim 16, wherein the heat exchanger includes a heat exchange plate filled with the phase change material.

18. The air cleaner as claimed in claim 17, wherein the heat exchange plate includes a plurality of pass through holes for pass of the introduced air.

19. The air cleaner as claimed in claim 18, wherein the fan is a sirocco fan for drawing air in an axial direction, and discharging in a circumferential direction.

20. The air cleaner as claimed in claim 19, wherein the air outlet is provided to a top of the case.
